(19) United States
(12) Patent Application Publication
(10) Pub. No.: US 2003/0233591 A1
(43) Pub. Date: Dec. 18, 2003

(54) Power state sub-system and a method of changing the power state of a selected computer system

(76) Inventors: Thierry Chiteboun, St. Egreve (FR); Cecile Puyo, Bernin (FR)

Correspondence Address: HEWLETT-PACKARD COMPANY, Intellectual Property Administration, P.O. Box 272400, Fort Collins, CO, 80527-2400, US

(21) Appl. No.: 10/371,180

(22) Filed: Feb. 24, 2003

(30) Foreign Application Priority Data
Feb. 22, 2002 (EP) 0

(51) Int. Cl. G06F 1/26

(52) U.S. Cl. 713/300

(57) ABSTRACT

A power state sub-system changes the power state of a computer system associated with the sub-system. The sub-system has (1) a wireless receiver responsive to control instructions including IDs for plural different computer systems and (2) a controller that changes the power state of the system associated with the sub-system in response to the instruction having the ID for that associated system. The sub-system is powered independently of the computer system, so its ability to receive control instructions is unaffected by the system's power state.

### FIELD OF THE INVENTION

The present invention relates to the general field of computer systems and relates, in particular, although not exclusively, to the field of power state sub-systems which are operative to control the various power states that the system is able to adopt.

### BACKGROUND ART

In recent years, many advances have been made concerning power management systems and associated power states that allow the power consumption of a computer system (e.g. a PC system) to be optimized in accordance with the demands placed on the system at a given time. The ACPI (Advanced Configuration and Power Interface) system provides an efficient power management system which allows a suitably-equipped PC, for example, to adopt one of a number of industry-defined power states in response to peripheral demands or user actions. The ACPI power states (also known as sleep states) range from S0, in which the CPU is operating normally, and in which a relatively high amount of power is consumed, to S5, in which no power is supplied to the CPU and in which the overall amount of power required by the system is very low (typically less than 5 watts). The S1, S2, S3 and S4 states reflect progressively lower degrees of CPU activity and overall power consumption, with transitions between the states typically occurring when the associated computer has been idle for a specific length of time or when a peripheral device requests the system to adopt a higher (i.e. increased activity) power state to allow the device to function correctly.

In industrial environments, where several (perhaps very many) computer systems are running side-by-side, the overall power consumption, when each system is operating at or near its full capacity, can be considerable. Similarly, a “fully on” PC, when connected to a network, can contribute to a decrease in the rate of flow of network traffic, with one object of the present invention thus being to provide a power state sub-system that is readily controllable in order to overcome or at least reduce these and other problems.

It is also an object of the present invention to provide a method of and apparatus for changing the power state of a selected computer system that is readily useable in industrial environments where access to the system hardware may be restricted.

### SUMMARY OF THE INVENTION

In accordance with a first aspect of the present invention, there is provided the combination of a computer system and a power state sub-system that is operative to change the system's power state. The sub-system has a receiver operative to receive wireless control instructions and a controller operative, in response to such instructions, to effect a change in the power state of the computer.

The sub-system can be powered independently of the computer system, whereby the ability of the sub-system to receive control instructions and control the computer system is unaffected by the power state of the computer system.

The control instructions can specify a particular power state to which a transition is required. Preferably, however, the change in power state involves a toggle between defined power states. Toggling enables a single control instruction to effect transitions between upper and lower power states.

Whichever approach is used, the lower power state preferably is one in which the system context is saved. Thus, when the system adopts the lower power state, the software context (i.e. status and content of any running applications) is recorded, thus allowing the context to be restored when the higher power state is resumed.

The system context can be saved to a system memory, preferably a volatile system memory such as RAM. Alternatively, the system context can be saved to a non-volatile storage device such as a hard disk drive (HDD).

The change in the system's power state can be effected using a ring indicator RI, USB or other such power management event (PME) signal. In this way, the sub-system can be connected to an appropriate serial, parallel or USB port with a predetermined signal generated by, or on the instruction of, the sub-system, being sent to the port concerned.

The wireless control instructions can include an identifier with the system's power state only being changed in response to the identifier being recognized.

In this way, erroneous changes in a system's power state are avoided by requiring, in the control instructions, the presence of an identifier or tag without which no change can be effected.

The identifier can be variable in accordance with a user's actions, whereby a user can selectively change the power state of one of a plurality of computer systems.

The control instruction can be transmitted using an infrared or a radio frequency carrier.

In accordance with a second aspect of the present invention, there is provided a method of changing the power state of a selected computer system of a plurality of computer systems, comprising generating a control instruction and effecting a wireless transmission of the control instruction towards a receiver of a sub-system associated with the computer system. A controller of the sub-system responds to the instruction, to change the power state of the selected computer system. The control instruction includes a computer system identifier such that the power state change is effected in the selected computer system.

The system identifier can be variable in accordance with a user's actions, whereby a user can selectively change the power state of one or more of the computer systems.

The control instruction can be transmitted using an infrared or a radio frequency carrier.

The invention, in its second aspect, can comprise one or more of the features described in relation to the first aspect.

### BRIEF DESCRIPTION OF THE DRAWING

The invention will now be described in greater detail, but strictly by way of example only, by reference to the accompanying drawings, of which;

FIG. 1 is a schematic illustration of a computer system having a number of available power states in combination with a sub-system for controlling the power state of the computer system;

FIG. 2 is a schematic diagram of a sub-system with an infrared receiver and a controller connected to a computer system in a number of different ways;

FIG. 3 is a flow diagram illustrating how the power state sub-system is initialized; and

FIG. 4 is a flow diagram showing how the power state sub-system operates, once initialized.

### DETAILED DESCRIPTION OF THE DRAWING

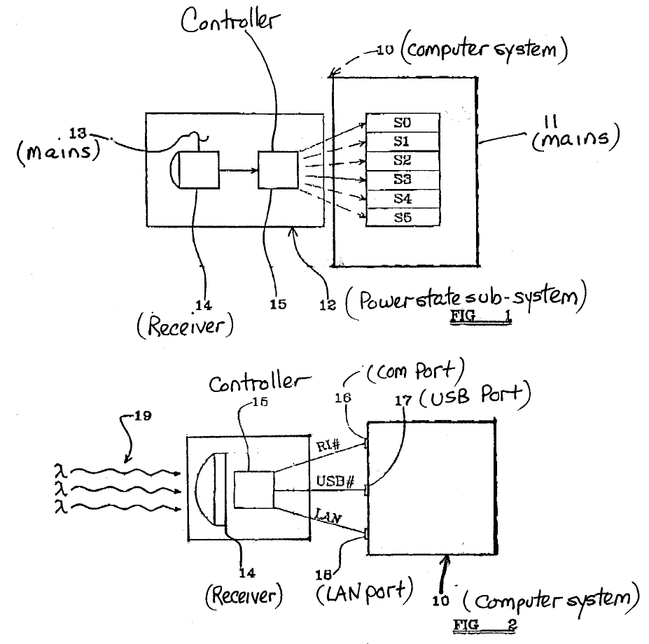

FIG. 1 is a diagram including a computer system 10, powered from a mains outlet 11, and a power state sub-system 12 powered from a separate mains outlet 13. The computer system 10 is intended to represent the key aspects of a PC, whose operation is influenced by the power state adopted by the system at a given time. However, the computer system 10 is not to be interpreted simply as referring to computer (e.g. PC) systems per se, but is intended also to encompass computerized systems such as those that may be found in a variety of devices such as printers, scanners, copiers, servers, fax machines and the like.

In a generally conventional manner, the computer system 10 is able to adopt one of a plurality of discrete power states (S0, S1, S2, S3, S4 and S5) such as are defined, from time to time, by industry-wide standards. The S0 to S5 power states (also known as sleep states) are currently defined by the ACPI (Advanced Configuration and Power Interface) standard, with the S0 and S5 sleep states respectively representing the highest the lowest level of system activity. These states, which are entered into in accordance with Operating System instructions, are all potentially available, although it is envisaged, in the present invention, that a toggle between the S0 and S3 states is likely to be the most convenient. This is because the S0 state (the so-called “working” state) is most commonly employed, and because the S3 state (in which the system context (e.g. software is saved to RAM) is commonly adopted—and hence accessible—using popular operating systems such as Microsoft Windows® Millennium Edition, Windows 2000 and Windows XP.

Broadly speaking, the power state sub-system 12 features a wireless receiver 14 and a controller 15 which, in response to wireless instructions received by the receiver 14, effects a change in the power state of system 10, as described in more detail below. In the example shown, the receiver 14 is a stand alone infrared carrier receiver, although it will be understood that other wireless carriers (such as RF) could similarly be employed.

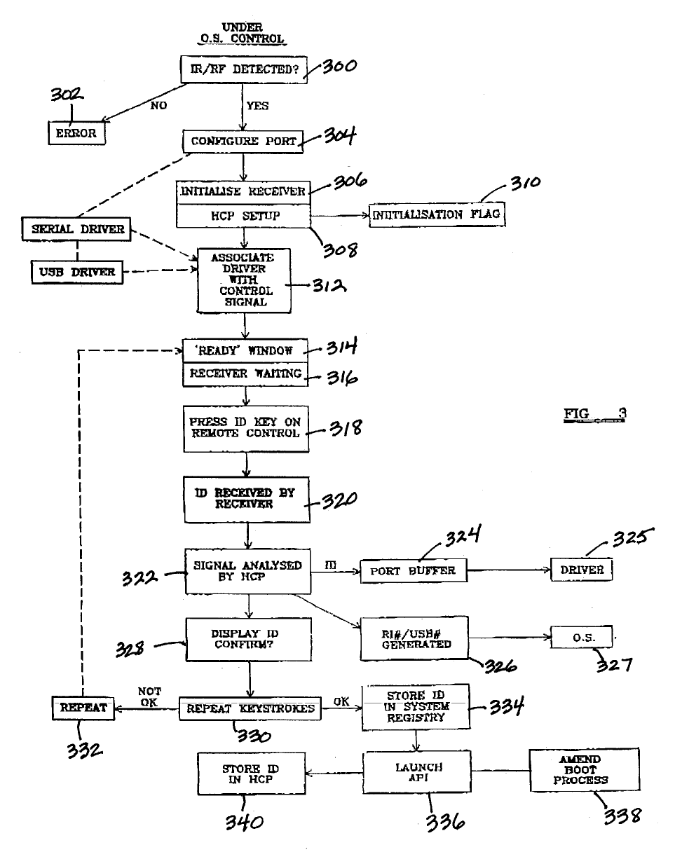

FIG. 2 is an illustration of the connection of controller 15 of sub-system 12 to the ports 16-18 of computer system 10. In brief, controller 15 sends control signals to the system 10 via a standard serial (COM) port 16, a USB port 17 or via a network (LAN) port 18. The different types of control signals are indicated by RI#, USB# and LAN, with the incoming wireless control instructions being shown generally by reference numeral 19.

FIG. 3 is a flow diagram of how the power state sub-system 15 associated with a particular computer system 10 is initialized and how a specific identifier (ID) is assigned to a particular computer system 10.

Under the control of the relevant Operating System (OS) of computer system 10, detection software of computer system 10 checks (during operation 300) whether any appropriate sub-systems 12 are connected to the computer system 10. If system 10 finds no such sub-system 12, the computer system 10 generates an error message (operation 302). If computer system 10 finds a relevant sub-system 12, the computer system configures (during operation 304) its associated port under software control of the computer system. The software of the particular computer system 10 then initializes (operation 306) the found sub-system 12 by configuring a hard-coded program (HCP) (operation 308) contained in controller 15 of the found sub-system 12, and specifically, by setting an initialization flag in the HCP memory (operation 310, FIG. 3.) This flag indicates that the found sub-system 12 is currently in the process of being initialized.

Subsequently, during operation 312, controller 15 of the found sub-system 12 associates a driver (a serial driver where a serial COM port is used; a USB driver where the USB port is used) of the controller with the relevant control signal. In the case of a serial COM port connected sub-system 12, controller 15 of the found sub-system generates a ring indicator (RI#) signal, whereas the controller generates a USB# signal if the controller 15 of sub-system 12 is connected to a USB port. In effect, this driver association allows the control signals of the formed sub-system 12 that are supplied to computer system 10 to be understood by the Operating System of the computer system 10 and hence acted upon by the computer system in order to effect a change in power state of the computer system, as described below.

The software of the Operating System of the particular computer system 10 then generates and causes display on the display of the particular computer operating system 10 an Operating System dialogue box indicating that the computer system has adopted a “ready” mode (operation 314) and that the receiver 14 of the found sub-system 12 is waiting for a wireless instruction (operation 316) from an appropriate remote control device. At the same time, the software of system 10 is awaiting a signal from the serial/USB driver of controller 15 in found sub-system 12, as appropriate.

In order to complete the initialization process, a user or another person who is controlling the power state (S0-S5) of the particular computer system 10 then, during operation 318, presses a particular key (not shown) (or sequence of keys) on a remote control handset (not shown) with the key or key sequence corresponding to an ID associated with the particular computer system. Activation of the key or key sequence causes a change in the power state of the particular computer system 10. This ID is sent from the handset to the receiver 14 of the found sub-system 12, and is received (operation 320) and analyzed (operation 322) by the HCP in controller 15 of the found sub-system 12. The HCP passes the thus-analyzed ID to a buffer of sub-system 12 associated with a port of controller 15 (operation 324) in turn associated with the appropriate port 16-18 of the particular computer system 10. The buffer generates an RI# or USB# signal (operation 326), as appropriate, which is supplied to a driver of the sub-system (operation 325). Controller 15 of the found sub-system supplies the RI# or USB# signal to the Operating System (operation 327) of the particular computer system 10 and the serial/USB driver of controller 15 obtains the thus-analyzed ID from the buffer. Controller 15 causes the software of the particular computer system 10 to then cause display of the chosen ID on a screen of the particular computer system 10 (operation 328), and seeks confirmation from the user that the ID is correct.

In order to effect this confirmation, the user enters into the remote control handset the same key or key/sequence (operation 328). The repeated key or key sequence is transmitted to the sub-system 12 associated with the particular computer system 10 and forwarded to the particular computer system 10, in the manner described above. The software of the particular computer system 10 analyzes the repeated signal and compares the analyzed signal with the first received ID which system 10 stored. If a match is not found (operation 332), the ID selection steps 314-328 are repeated. If a match is found (operation 334), however, the software of system 10 stores the ID in a system registry (e.g. a Windows® Registry) and launches an Application Program Interface (API) (operation 336) that is operative to await a power state control signal emanating from the HCP of controller 15 of the found sub-system 12. After operation 336, computer system 10 slightly amends its boot process (operation 338) to ensure that the API is run each time the computer system is booted. At the same time, the API of computer system 10 sends a command to the HCP of controller 15 of the found sub-system 12. The command causes the HCP to store the thus-confirmed ID (operation).

From the above, it will be understood that the use of a plurality of different ID's allows control of selected computer systems, without the requirement of different transmission frequencies from the handset devices to receiver 14 of different sub-systems 12. It is, however, to be appreciated that different systems could be made responsive to different transmission frequencies, if desired.

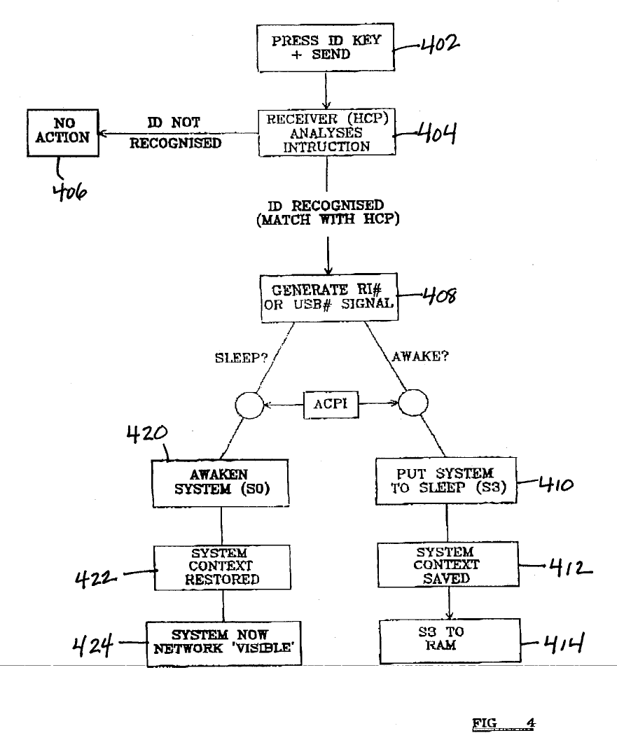

In order to change the power state of a particular computer system 10, the relevant ID is supplied to the remote handset and the thus-generated instruction is transmitted wirelessly (operation 402, FIG. 4) towards the receiver 14 of the concerned sub-system 12. The HCP of the controller 15 of the concerned sub-system 12 analyzes the instruction (operation 404) and checks whether the thus-analyzed ID matches the ID previously stored in the HCP memory during operation 340. If no match is found, the ID is designated “not recognized” and no further action is taken (operation 406).

If a match is found, and the ID is recognized, the HCP, during operation 408, generates an RI# or USB# signal (depending on whether the receiver is connected to the serial COM or USB port of system 10). The incoming RI# or USB# signal is intercepted by the appropriate driver in controller 15 of sub-system 12 and forwarded, using the API of system 10, to the ACPI functionality located within the main Operating System of system 10. If the system 10 is found to be “awake” (e.g. in the SO state), the ACPI thereof is operative to effect a downward transition to a sleep state such as S3 (operation 410). In the S3 state, the context of system 10 (e.g. data and application content) is saved (operation 412) to a volatile memory portion (such as the RAM) of the system 10 (operation 414). Alternatively, a downward transition to an S4 sleep state can be effected, in which case the context of system 10 is saved to a non-volatile storage device, such as an HDD, of system 10.

The Operating System of system 10 also then informs a chipset of controller 15 of the various signals and events (RI#, USB# or PME, for example) that controller 15 needs to derive and perform to wake the system 10 from the sleep state, at some point in the future. Future wake up is in response to the hand held transmitter wirelessly transmitting to sub-system 12 a signal having the ID of the particular computer system 10 associated with the sub-system.

After the Operating System of system 10 informs the chipset, the Operating System instructs the BIOS of system 10 to prepare to enter the appropriate sleep state which, in the case of S3, halts operation of the CPU. In the case of S4, the Operating System effects a more thorough “power-off” of the computer system 10 and supplies the chipset with different signals needed to wake the computer system 10.

However, in response to the ACPI finding the computer system 10 in a “sleeping” state (such as S3 or S4) when a port 16-18 of system 10 receives a signal from controller 15, the ACPI of computer system 10 is operative to generate a “wake” signal, thus bringing the system up to the SO working state, for example (operation 420).

If an awakening from S3 is effected, the CPU of system 10 recommences operation; where an awakening from S4 occurs, however, power must first be restored to the system. Whichever occurs, the BIOS of system 10 initially takes control, passing the control promptly to the Operating System of system 10 in the case of an S3 awakening. Where an S4 awakening is effected, the BIOS executes a rapid reboot of system 10 and then passes control to the Operating System. If the system 10 has been awakened from an S3 or S4 sleep state, the control of system 10 (including any open application or uncompleted tasks) is restored (operation 422), under OS control, meaning that the system 10 is returned to the exact point where it was when the system 10 entered the S3 or S4 sleep state.

In hand with that, the thus-awoken system 10 is rendered “visible” (operation 424) to any network components to which it may be connected, in contrast to its “invisible” status that corresponds to the sleep states of system 10.

As will be understood from the foregoing, an aspect of the invention allows selected computer system 10 to be powered up or down in accordance with a user request, on a wireless remote basis, with the power state of the computer system 10 having no influence on the ability of its associated sub-system 12 including wireless receiver 14 to initiate the power state change, because the sub-system is powered independently of its associated system 10.

In hand with that, the invention effectively allows computer system network elements, equipped with appropriately configured wireless receivers, to be added to, or removed from, a network topology by altering their power states and thus whether or not they play any substantial part in network activity.

The remote and wireless operability of the invention allows power state changes of computer systems to be made to relatively inaccessible systems such as are found, for example, in industrial workplaces, where the systems are frequently protected by safety screens and the like.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. In combination, a computer system; a power state sub-system, operative to change the power state of the computer system, the sub-system having (a) a receiver operative to receive wireless control instructions and (b) a controller operative, in response to the received instructions, to change the power state of the computer system.

2. The combination according to claim 1 wherein the receiver is arranged to be powered independently of the computer system, whereby the receiver can receive control instructions regardless of the power state of the computer system.

3. The combination according to claim 1 wherein the change in power state includes a toggle between defined power states.

4. The combination according to claim 1 wherein one of the power states is lower than normal operating power of the computer system and is a power state in which context of the computer system is adapted to be saved.

5. The combination according to claim 4 wherein the computer system is arranged for causing the system context to be saved to a memory system of the computer.

6. The combination according to claim 1 wherein the sub-system and system are arranged for causing the power state change of the computer system to be effected by a ring indicator, USB or other such power management event signal.

7. The combination according to claim 1 wherein the wireless control instructions include an identifier and wherein the system and sub-system are arranged so the power state of the system is only changed in response to the identifier being recognized.

8. A method of changing the power state of a selected computer system of a plurality of computer systems, comprising generating a control instruction including a computer system identifier for the selected computer system, wirelessly transmitting the control instruction towards a receiver, and changing the power state of the selected system in response to the instruction.

9. A method according to claim 8 wherein the system identifier is variable in accordance with a user's actions, the user selectively changing the power state of one or more of the systems.

10. A method according to claim 8 wherein the control instruction is transmitted on an infrared or a radio frequency carrier.

11. A sub-system adapted to be responsive to a wireless command signal for controlling the power state of a computer system having a power supply, the sub-system comprising: (a) a power supply independent of the computer system power supply, (b) a receiver for the wireless command signal, and (c) a controller arranged to be responsive to the receiver receiving the command signal for deriving a control signal for a power state of the computer system.

12. In combination, a first computer system having an identification different from identifications of other second computer systems adapted to be in proximity with the first computer system, the first computer system having a power supply, a sub-system adapted to be responsive to a command signal for controlling the power state of the first computer system, the command signal including an indication of the identification of the first computer system, the sub-system including (a) a power supply independent of the first computer system power supply, (b) a receiver for the command signal, and (c) a controller arranged to be responsive to the receiver receiving the command signal for coupling a control signal for a power state of the first computer system to the first computer system, one of the power states of the computer system being lower than normal operating power of the computer system, the sub-system and first computer system being arranged so that the power state is changed only in response to the sub-system receiving the command signal including the identification indication of the first computer system.

13. A sub-system adapted to be responsive to a command signal for controlling the power state of a first computer system having a power supply, the first computer system having an identification different from identifications of other second computer systems adapted to be in proximity with the first computer system, the first computer system having a power supply and plural power states, the sub-system comprising: (a) a receiver for a command signal for controlling the power state of the first computer system, the command signal including an indication of the identification of the first computer system, (b) a power supply independent of the first computer system power supply, and (c) a controller arranged to be responsive to the receiver receiving the command signal for coupling a control signal for a power state of the first computer system to the first computer system, the sub-system being arranged to supply a signal to the first computer system for causing the first computer system power state to change only in response to the sub-system receiving the command signal including the identification indication of the first computer system.
